(19) United States
(12) Patent Application Publication
(10) Pub. No.: US 2025/0229493 A1
(43) Pub. Date: Jul. 17, 2025

(54) METHOD AND DEVICE FOR CONTROLLING MOVEMENT OF PRINT HEAD, ELECTRONIC DEVICE AND STORAGE MEDIUM

(71) Applicant: Shenzhen Anker Smart Technology Co., Ltd, Shenzhen (CN)

(72) Inventor: Tingjian Huang, Shenzhen (CN)

(21) Appl. No.: 19/011,870

(22) Filed: Jan. 7, 2025

(30) Foreign Application Priority Data
Jan. 17, 2024 (CN) 202410071277.7

(51) Int. Cl. B29C 64/393; B29C 64/118; B29C 64/321; B33Y 40/00; B33Y 50/02

(52) U.S. Cl. CPC B29C 64/393; B29C 64/321; B33Y 40/00; B33Y 50/02; B29C 64/118

(57) ABSTRACT

Examples of the present disclosure provide a method and a device for controlling movement of a print head, an electronic device and a storage medium. The method includes determining an idling point on an operation path, and determining a material withdrawing and refilling point based on the idling point, wherein the material withdrawing and refilling point is located before at least one of the idling start point and the idling end point; controlling the print head to start a material withdrawing and refilling operation in a case where the print head moves to the material withdrawing and refilling point according to the operation path; and controlling the print head to move to the idling end point. By performing the material withdrawing and refilling operation before the print head reaches the idling point, this approach reduces or even eliminates the occurrence of nozzle stringing, thereby improving printing quality.

### CROSS-REFERENCE TO RELATED APPLICATION

The present disclosure claims the priority of Chinese Patent Application No. 202410071277.7, filed on Jan. 17, 2024, which is incorporated herein by reference in its entirety.

### FIELD

The disclosure relates to the field of three-dimensional printing, in particular to a method and a device for controlling movement of a print head, an electronic device and a storage medium.

### BACKGROUND

In related technologies, a fused deposition modeling (FDM) process is generally adopted for three-dimensional (3D) printing. During the printing process, a mechanism for handling idling movement typically involves stopping the motion of the print head before initiating the idling movement. Then, an extrusion shaft performs a material withdrawing operation. Once the material withdrawing operation is complete, the idling movement starts. After the idling movement is made in place, a material refilling operation is performed, followed by a continuation of outline or contour printing. Moreover, due to the extrusion characteristics of the printer, stringing issues such as oozing or webbing at a nozzle frequently occurs at the start and end points of the idling movement, resulting in poor printing quality.

It can be seen that it is a technical problem worthy of attention to improve the printing effect.

### SUMMARY

In order to solve some or all of the above technical problems, examples of the disclosure provide a method and a device for controlling movement of a print head, an electronic device and a storage medium.

In a first example, an example of the disclosure provides a method for controlling movement of a print head, including: determining an idling point on an operation path, wherein the idling point includes an idling start point and an idling end point; determining a material withdrawing and refilling point based on the idling point, wherein the material withdrawing and refilling point is located before at least one of the idling start point and the idling end point; controlling the print head to start a material withdrawing and refilling operation in a case where the print head moves to the material withdrawing and refilling point according to the operation path; and controlling the print head to move to the idling end point.

In a possible example, the material withdrawing and refilling point includes a material withdrawing point and a material refilling point, and determining a material withdrawing and refilling point based on the idling point includes: determining a material withdrawing point based on the idling start point, wherein the print head performs a material withdrawing operation in a case where the print head moves to the material withdrawing point; and determining a material refilling point based on the idling end point. The print head performs a material refilling operation in a case where the print head moves to the material refilling point, and controlling the print head to move to the idling end point includes: controlling the print head to move in the following order: the material withdrawing point, the idling start point, the material refilling point, and the idling end point.

In a possible example, after determining an idling point on an operation path, the method further includes: constructing a target idling path between the idling start point and the idling end point; and updating a path between the idling start point and the idling end point in the operation path to the target idling path to obtain an updated operation path. Controlling the print head to move to the idling end point includes: controlling the print head to move to the idle end point according to the updated operation path.

In a possible example, the target idling path satisfies at least one of the following conditions: a curve representing the idling path has first-order continuity; a curve representing the idling path satisfies a preset curvature condition; or a curve representing the idling path satisfies a preset curvature variation condition.

In a possible example, the idling path is constructed in the following manner: determining a first straight line and a second straight line, wherein the first straight line represents a straight line in a moving direction of the print head at the idling start point, and the second straight line represents a straight line in a moving direction of the print head at the idling end point; and determining a target idling path based on the idling start point, the first straight line, the idling end point and the second straight line, wherein the target idling path is two tangential circles, a tangent of the two tangential circles at the idling start point is the first straight line, and a tangent of the two tangential circles at the idling end point is the second straight line.

In a possible example, the idling path is constructed in the following manner: determining an initial function relation formula for path construction, wherein the initial function relation formula contains parameters to be determined; determining a constraint equation of the initial function relation formula; and determining a target function relation formula representing the curve of the idling path based on the constraint equation and the initial function relation formula to construct the target idling path.

In a possible example, determining a material withdrawing and refilling point based on the idling point includes: determining the material withdrawing and refilling point based on a preset target distance and the idling point, wherein the target distance represents a distance between the idling point and the material withdrawing and refilling point to be determined.

In a second aspect, an example of the disclosure provides a device for controlling movement of a print head, including: a first determining unit configured to determine an idling point on an operation path, wherein the idling point includes an idling start point and an idling end point; a second determining unit configured to determine a material withdrawing and refilling point based on the idling point, wherein the material withdrawing and refilling point is located before at least one of the idling start point and the idling end point; and to control the print head to start a material withdrawing and refilling operation in a case where the print head moves to the material withdrawing and refilling point according to the operation path; and a control unit configured to control the print head to move to the idling end point.

In a possible example, the material withdrawing and refilling point includes a material withdrawing point and a material refilling point, and determining a material withdrawing and refilling point based on the idling point includes: determining a material withdrawing point based on the idling start point, wherein the print head performs a material withdrawing operation in a case where the print head moves to the material withdrawing point; and determining a material refilling point based on the idling end point, wherein the print head performs a material refilling operation in a case where the print head moves to the material refilling point, and controlling the print head to move to the idling end point includes: controlling the print head to move in the following order: the material withdrawing point, the idling start point, the material refilling point, and the idling end point.

In a possible example, the device further includes: a constructing unit configured to construct a target idling path between the idling start point and the idling end point; and an updating unit configured to update a path between the idling start point and the idling end point in the operation path to the idling path to obtain an updated operation path after determining an idling point on an operation path; and controlling the print head to move to the idling end point includes: controlling the print head to move to the idling end point according to the updated operation path.

In a possible example, the target idling path satisfies at least one of the following conditions: a curve representing the idling path has first-order continuity; a curve representing the idling path satisfies a preset curvature condition; or a curve representing the idling path satisfies a preset curvature variation condition.

In a possible example, the target idling path is constructed in the following manner: determining a first straight line and a second straight line, wherein the first straight line represents a straight line in a moving direction of the print head at the idling start point, and the second straight line represents a straight line in a moving direction of the print head at the idling end point; and determining a target idling path based on the idling start point, the first straight line, the idling end point and the second straight line, wherein the target idling path is two tangential circles, a tangent of the two tangential circles at the idling start point is the first straight line, and a tangent of the two tangential circles at the idling end point is the second straight line.

In a possible example, the idling path is constructed in the following manner: determining an initial function relation formula for path construction, wherein the initial function relation formula contains parameters to be determined; determining a constraint equation of the initial function relation formula; and determining a target function relation formula representing the curve of the idling path based on the constraint equation and the initial function relation formula to construct the target idling path.

In a possible example, determining a material withdrawing and refilling point based on the idling point includes: determining the material withdrawing and refilling point based on a preset target distance and the idling point, wherein the preset target distance represents a distance between the idling point and the material withdrawing and refilling point to be determined.

In a third aspect, an example of the disclosure provides an electronic device including: a memory configured to store a computer program; and a processor configured to execute the computer program stored in the memory and meanwhile implement the method for controlling movement of a print head according to any of the examples in the first aspect of the present disclosure.

In a fourth aspect, an example of the disclosure provides a computer-readable storage medium where a computer program is stored, and when the computer program is executed by a processor, the method for controlling movement of a print head according to any of the examples in the first aspect of the present disclosure is implemented.

In a fifth aspect, an example of the disclosure provides a computer program including a computer-readable code, and when the computer-readable code is run on a device, a processor in the device implements the method for controlling movement of a print head according to any of the examples in the first aspect of the present disclosure.

The method for controlling movement of a print head according to the examples of the present disclosure includes: determining an idling point on an operation path, and then determining a material withdrawing and refilling point based on the idling point, wherein the material withdrawing and refilling point is located before at least one of the idling start point and the idling end point; controlling the print head to start a material withdrawing and refilling operation in a case where the print head moves to the material withdrawing and refilling point according to the operation path; and controlling the print head to move to the idling end point. Therefore, the material withdrawing and refilling operation can be performed by the print head before the print head reaches the idling point, thereby reducing or even avoiding occurrence of stringing at a nozzle caused by not performing the material withdrawing and refilling operation when the print head reaches the idling point, and improving printing quality.

### BRIEF DESCRIPTION OF THE DRAWINGS

Accompanying drawings, which are incorporated in and constitute a part of this specification, illustrate examples according to the disclosure, which together with the specification serve to explain principles of the disclosure.

In order to more clearly illustrate examples of the disclosure or technical solutions in the related art, the drawings that need to be used in description of the examples or the related art are briefly introduced below, and it is apparent to those of ordinary skill in the art that other drawings can be obtained based on these drawings without inventive work.

One or more examples are illustrated by the corresponding drawings, which does not constitute a limitation of the examples. Elements with the same reference numerals in the drawings represent similar elements, and the drawings do not constitute a scale limitation unless otherwise specified.

FIG. 1 is a flowchart of a method for controlling movement of a print head according to an example of the present disclosure;

FIG. 2 is a flowchart of another method for controlling movement of a print head according to an example of the present disclosure;

FIG. 3A is a flowchart of yet another method for controlling movement of a print head according to an example of the present disclosure;

FIG. 3B is a schematic diagram of an idling path involved in a method for controlling movement of a print head according to an example of the present disclosure;

FIG. 4 is a schematic diagram of a device for controlling movement of a print head according to an example of the present disclosure; and

FIG. 5 is a schematic diagram of an electronic device according to an example of the present disclosure.

### DETAILED DESCRIPTION

Various exemplary examples of the present disclosure will now be described in detail with reference to the accompanying drawings. Obviously, the described examples are a part, but not all, of the examples of the present disclosure. It should be noted that relative arrangement, numerical expressions and numerical values of components and operations set forth in these examples do not limit a scope of the disclosure, unless otherwise specified.

Various exemplary examples of the present disclosure will now be described in detail with reference to the accompanying drawings, and it is apparent that the described examples are some but not all of the examples of the present disclosure. It should be noted that: unless specifically stated otherwise, the relative arrangement of components and steps, numerical expressions, and numerical values set forth in these examples are not intended to limit the scope of the present disclosure.

Those skilled in the art can understand that terms such as “first” and “second” in the examples of the present disclosure are only used to distinguish objects such as different steps, devices, or modules, and neither represent any specific technical meaning nor the logical order between them.

It should also be understood that in the present example, “a plurality” may refer to two or more, and “at least one” may refer to one, two or more.

It should also be understood that any component, data, or structure mentioned in the examples of the present disclosure can generally be understood as one or more unless explicitly defined or otherwise indicated in the foregoing and hereinafter.

In addition, “and/or” only describes an associating relationship between associated objects and indicates that there may be three relationships. For example, A and/or B, which may mean: three cases of A alone, A and B at the same time, and B alone. The character “/” generally indicates that the former and latter associated objects are in an “or” relationship.

It should also be understood that the description of various examples in the present disclosure strongly emphasizes the differences between the various examples, and the same or similar parts thereof may be referred to each other and will not be repeated.

The following description of at least one exemplary example is merely illustrative actually and is in no way intended to limit the present disclosure and application or use thereof.

Techniques, methods, and devices known to those of ordinary skill in the related art may not be discussed in detail, but should be regarded as part of the specification where appropriate.

It should be noted that: like reference numerals and letters refer to like items in the following drawings, and therefore, once an item is defined in a drawing, it is not necessary to further discuss the item in the subsequent drawings.

It is to be noted that the examples and features in the examples of the present disclosure may be combined with each other in the case of no conflict. To facilitate the understanding of the examples of the disclosure, the present disclosure will be described in detail below with reference to the drawings and in conjunction with the examples. It is apparent that the described examples are some but not all of the examples of the present disclosure. Based on the examples of the disclosure, all other examples obtained by those of ordinary skill in the art without inventive work shall fall within the scope of the disclosure.

In order to solve the technical problem of how to improve the printing effect in the related art, a method for controlling movement of a print head is provided in the disclosure, which can improve the printing effect.

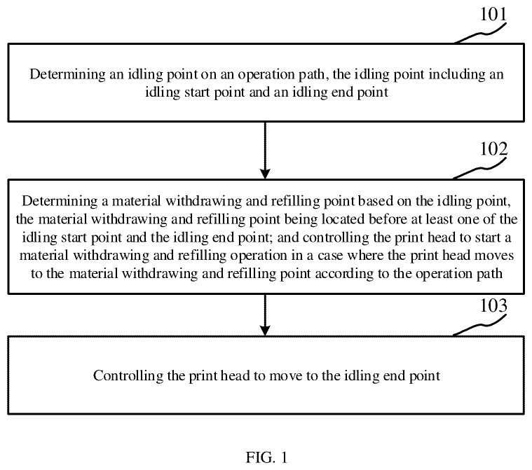

FIG. 1 is a flowchart of a method for controlling movement of a print head according to an example of the present disclosure. The method can be applied to one or more electronic devices such as 3D printers, smart phones, notebook computers, desktop computers, portable computers and servers. In addition, an execution subject of the method can be hardware or software. When the execution subject is the hardware, the execution subject can be one or more of the electronic devices described above. For example, a single electronic device may perform the method, or a plurality of electronic devices may perform the method in cooperation with each other. When the execution subject is the software, the method can be implemented as multiple software or software modules, or as a single software or software module. This is not specifically limited here.

As shown in FIG. 1, the method includes operations 101 to 103.

At operation 101, an idling point on an operation path is determined. The idling point includes an idling start point and an idling end point. In this example, the operation path may be a path for the print head to operate (e.g., move) determined using various known methods. As an example, the operation path can be a path determined by using at least one of the following path planning algorithms: a quick splicing algorithm of intersecting line segments based on dictionary query, a quick determination method of plane-curve inclusion relation, a partition method of contour regions based on concave peak points, a filling direction optimization method with minimum tool skipping, a printing support optimization method based on improved particle swarm optimization, a model end-face identification method based on Boolean operation, and the like.

The operation path (which can include a printing path and an idling path) can be used to indicate a moving mode of the print head. In other words, the print head can move according to indication of the operation path, and perform one or more operations such as material extrusion, material refilling, material withdrawing, idling and the like during the movement.

Idling or idling movement can mean that the print head moves without extruding the material. The material described above may be a material used for extrusion to form a printed matter, for example, plastic.

The withdrawing can refer to an operation to prevent crossed extrusion or dripping during printing. When the print head needs to move to a new position without extruding the material, the printer can slightly pull (withdraw) the material back to inside of the print head to prevent the material from dripping during movement, thus avoiding stringing phenomenon related to dripping.

In addition, when the print head arrives at a new printing position after withdrawing and is ready to start material extrusion again, the printer can push out (refill) the previously withdrawn material again, that is, push the material into the print head in advance so that the print head is ready to re-extrude the material.

Thus, the operation path can include: a path for the print head to perform the material extrusion (which can be called an extrusion path or printing path) and a path for the print head to idle (which can be called the idling path).

The idling point can be one or more points on the idling path. As an example, the idling point may include an idling start point and an idling end point. The idling start point can represent a first point of the idling path. The idling end point can represent a last point of the idling path.

At operation 102, a material withdrawing and refilling point is determined based on the idling point, the material withdrawing and refilling point is located before at least one of the idling start point and the idling end point; and the print head is controlled to start a material withdrawing and refilling operation in a case where the print head moves to the material withdrawing and refilling point according to the operation path.

In this example, when the print head moves to the material withdrawing and refilling point, or within a certain period of time before or after this (which can be determined based on a response speed of the print head, etc.), the print head can perform the material withdrawing and refilling operation.

When the print head moves to the material withdrawing and refilling point, the print head can start to perform (e.g., initiate) the material withdrawing and refilling operation. It should be understood that it usually takes a certain period of time to perform the material withdrawing and refilling operation.

In some cases, the material withdrawing and refilling point may include at least one of a material withdrawing point and a material refilling point. For example, in a case where the idling point includes the idling start point, the material withdrawing and refilling point may include the material withdrawing point, at which the print head starts the material withdrawing operation. When the idling point includes the idling end point, the material withdrawing and refilling point can include the material refilling point, at which the print head starts the material refilling operation.

Here, it should be noted that after the operation path is updated, the print head may move according to the updated operation path. In practice, there are many ways to determine the material withdrawing and refilling point based on the idling point.

In some alternative implementations of this example, a following way can be adopted to determine the material withdrawing and refilling point based on the idling point.

The material withdrawing and refilling point is determined based on a preset target distance and the idling point. The target distance represents a distance between the idling point and the material withdrawing and refilling point to be determined.

The target distance can be set in advance (for example, determined by experience) or determined based on response characteristics of an extruder in the printer.

As an example, a point that meets a preset condition can be determined in the operation path and used as the material withdrawing and refilling point. The point that meets the preset condition can be located before the idling point, and a distance between the point that meets the preset condition and the idling point is the determined distance above.

Here, when the idling point is the idling start point, the material withdrawing and refilling point can be the material withdrawing point. When the idling point is the idling end point, the material withdrawing and refilling point can be the material refilling point.

It can be understood that in the above alternative implementation, the distance between the idling point and the material withdrawing and refilling point can be determined, and the material withdrawing and refilling point can be determined according to the distance. In this way, a speed of determining the material withdrawing and refilling point can be improved.

Alternatively, the response characteristics of the extruder along with exponential acceleration and deceleration can be used to determine the material withdrawing and refilling point based on the idling point.

At operation 103, the print head is controlled to move to the idling end point.

In this example, in a process where the print head moves on the operation path for printing, idling or other operations, the print head can be moved from the material withdrawing and refilling point to the idling point. In other words, the print head can first reach the material withdrawing and refilling point and then move to the idling point.

Here, in a process that the print head moves from the material withdrawing and refilling point to the idling point, the print head can continue to perform the material withdrawing and refilling operation.

As an example, in a case where the material withdrawing and refilling point includes the material withdrawing point and the idling point includes the idling start point, the print head can be controlled to perform the material withdrawing operation at the material withdrawing point, and the print head can be controlled to move from the material withdrawing point to the idling start point.

In addition, in a case where the material withdrawing and refilling point includes the material refilling point and the idling point includes the idling end point, the print head can be controlled to move in a following order: the material withdrawing point, the idling start point, the material refilling point, and the idling end point.

In a process that the print head performs the material withdrawing and refilling operation, due to characteristics of the material itself, although the print head does not exert an extrusion force on the material therein, the material in the print head can still drip. When the print head moves to or before the idling start point, the print head completes the material withdrawing and refilling operation, that is, the material in the print head stops dripping at the idling start point.

In some cases, after the print head is moved from the material withdrawing point to the idling start point, the print head can be further moved from the idling start point to the material refilling point, and then to the idling end point.

In the method for controlling movement of the print head according to the example of the disclosure, the idling point on the operation path is determined, and then the material withdrawing and refilling point is determined based on the idling point. The material withdrawing and refilling point is located before at least one of the idling start point and the idling end point; and the print head is controlled to start a material withdrawing and refilling operation in a case where the print head moves to the material withdrawing and refilling point according to the operation path. Then, the print head is controlled to move to the idling end point. Therefore, the material withdrawing and refilling operation can be performed by the print head before the print head reaches the idling point, thereby reducing or even avoiding occurrence of stringing at a nozzle caused by not performing the material withdrawing and refilling operation when the print head reaches the idling point, and improving printing quality. Moreover, in the conventional technologies, in order to suppress stringing phenomenon, the print head is allowed to wait for the residual material in the print head to flow out at the idling start point before starting the idling; and the print head is allowed to wait for the material to melt in the print head at the idling end point and then starts normal printing. Therefore, in this scheme, by withdrawing in advance before the idling start point and refilling in advance before the idling end point, the print head does not need to wait at the idling start point or the idling end point, which saves a duration for the print head to move in idling and can improve printing efficiency.

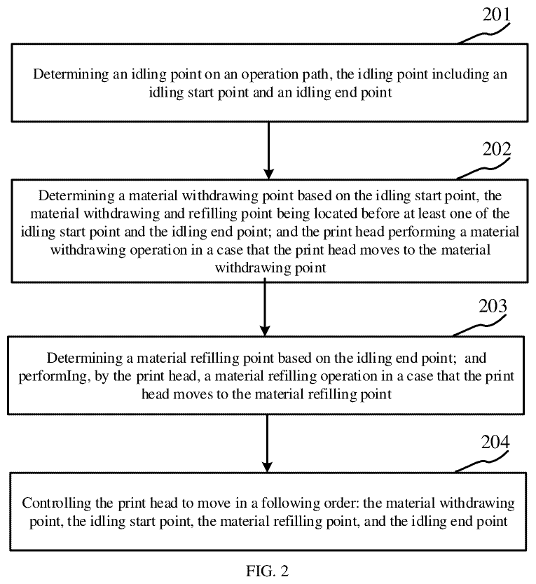

FIG. 2 is a flowchart of another method for controlling movement of a print head according to an example of the present disclosure. As shown in FIG. 2, the method specifically includes operations 201 to 204.

At operation 201, an idling point on an operation path is determined. The idling point includes an idling start point and an idling end point. In this example, operation 201 is similar to operation 101 in the corresponding example of FIG. 1, which will not be repeated here.

At operation 202, a material withdrawing point is determined based on the idling start point, the material withdrawing and refilling point is located before at least one of the idling start point and the idling end point; and the print head performs a material withdrawing operation in a case where the print head moves to the material withdrawing point.

In this example, when the print head moves to the material withdrawing point, or within a certain period of time before or after this (which can be determined based on a response speed of the print head, etc.), the material withdrawing operation can be performed. It should be understood that it usually takes a certain time to perform the material withdrawing operation.

In some alternative implementations of this example, in a case where the idling point includes the idling start point and the material withdrawing and refilling point includes the material withdrawing point, a following method can be adopted to determine the material withdrawing point based on the idling start point.

The material withdrawing point is determined based on a preset target distance and the idling start point. The target distance represents a distance between the idling start point and the material withdrawing point to be determined. The target distance can be set in advance or determined based on response characteristics of the material in the printer.

As an example, a point that meets a first condition can be determined in the operation path and used as the material withdrawing point. The point that meets the first condition is located before the idling start point, and a distance between the point that meets the first condition and the idling start point is the distance determined above.

It can be understood that in the above alternative implementation, the distance between the idling point and the material withdrawing and refilling point to be determined can be determined, and the material withdrawing and refilling point can be determined according to the distance. In this way, a speed of determining the material withdrawing and refilling point can be improved.

At operation 203, a material refilling point is determined based on the idling end point; the print head performs a material refilling operation in a case where the print head moves to the material refilling point.

In this example, when the print head moves to the material refilling point, or within a certain period of time before or after this (which can be determined based on a response speed of the print head, etc.), the material refilling operation can be performed. It should be understood that it usually takes a certain time to perform the material refilling operation.

In some alternative implementations of this example, in a case where the idling point includes the idling start point and the material withdrawing and refilling point includes the material refilling point, a following way can be adopted to determine the material refilling point based on the idling point.

The material refilling point is determined based on a preset target distance and the idling end point. The preset target distance represents a distance between the idling end point and the material refilling point to be determined.

The target distance can be set in advance or determined based on response characteristics of the material in the printer.

As an example, a point that meets a second condition can be determined in the operation path and used as the material refilling point. The point that meets the second condition is located before the idling end point, and a distance between the point that meets the second condition and the idling start point is the determined distance above.

It can be understood that in the above alternative implementation, the distance between the idling end point and the material refilling point can be determined, and the material refilling point can be determined according to the distance. In this way, a speed of determining the material refilling point can be improved.

At operation 204, the print head is controlled to move in the following order: the material withdrawing point, the idling start point, the material refilling point, and the idling end point.

In this example, in a process that the print head moves on the operation path for printing, the print head can move from the material withdrawing point to the idling start point, then from the idling start point to the material refilling point, and then from the material refilling point to the idling end point. Here, in a process that the print head moves from the material withdrawing point to the idling start point, the print head can continue to perform the material withdrawing operation. In a process that the print head moves from the material refilling point to the idling end point, the print head can continue to perform the material refilling operation.

In some alternative implementations of this example, after the idling point on the operation path is determined, the following operations can be performed:

First, a target idling path is constructed between the idling start point and the idling end point. The target idling path may be any path constructed between the idling start point and the idling end point.

Second, a path between the idling start point and the idling end point in the operation path is updated to the idling path to obtain an updated operation path. The updated operation path may be a path obtained by updating the path between the idling start point and the idling end point in the operation path to the idling path.

Third, the print head is controlled to move according to the updated operation path.

It can be understood that in the alternative implementations, the idling path in the operation path can be updated so that the idling path that meets the preset condition can be obtained, so as to realize re-planning of the idling path.

In some application scenarios in the above alternative implementations, the target idling path satisfies at least one of the following conditions:

First condition: a curve representing the idling path has first-order continuity.

Here, the curve representing the idling path may have at least the first-order continuity. For example, the curve representing the idling path may only have the first-order continuity, but not second-order continuity. Alternatively, the curve representing the idling path may only have the first-order continuity and the second-order continuity, but not third-order continuity. In other words, the curve representing the idling path may have CN continuity.

The CN continuity means that a function is continuous in its domain, and all its derivatives are also continuous. Here, “N” indicates an order of derivative, for example, C0 continuity means that the function itself is continuous, C1 continuity means that the function itself and its first-order derivative are continuous, C2 continuity means that the function itself, its first-order derivative and its second-order derivative are continuous, and the like.

Second condition: the curve representing the idling path satisfies a preset curvature condition.

The preset curvature condition can be any one or more conditions set for the curve for limiting a curvature thereof. As an example, the preset curvature condition may include at least one of the following:
a construction goal of the curve representing the idling path includes a minimum curvature of the curve; or
a curvature of the curve representing the idling path is less than or equal to a preset curvature threshold.

Here, the construction goal of the idling path including the minimum curvature of the curve representing the idling path means that the curvature of the curve representing the idling path obtained subsequently is as small as possible.

It should be understood that with the minimum curvature as the goal, it does not mean that the curvature of the curve corresponding to the idling path can only be of minimum.

Third condition: the curve representing the idling path satisfies a preset curvature variation condition.

The preset curvature variation condition can be any one or more conditions for limiting a curvature of the curve set for the curve. As an example, the preset curvature variation condition may include at least one of the following:
a construction goal of the curve representing the idling path includes a minimum curvature variation of the curve; or
a curvature variation of the curve representing the idling path is less than or equal to a preset curvature variation threshold.

Here, the construction goal of the idling path including the minimum curvature variation of the curve representing the idling path means that the curvature variation of the curve representing the idling path obtained subsequently is as small as possible.

It should be understood that with the minimum curvature variation as the goal, it does not mean that the curvature variation of the curve corresponding to the idling path can only be of minimum.

It can be understood that in the above application scenarios, in a case where the preset condition includes the first condition described above, a smooth idling path can be constructed, so that speed reduction at the idling start point and the idling end point is not obvious, which shortens a waiting duration for process execution and a duration for speed reduction at the idling start point and the idling end point. In a case where the preset condition includes the second condition above, the curvature of the curve representing the idling path can be made as small as possible. In a case where the preset condition includes the third condition above, the curvature variation of the curve representing the idling path can be made as small as possible.

In some application scenarios in the above alternative implementations, the idling path is constructed in the following manner:

First, a first straight line and a second straight line are determined.

The first straight line represents a straight line in a moving direction of the print head at the idling start point, and the second straight line represents a straight line in a moving direction of the print head at the idling end point.

As an example, a first position, the first straight line, a second position and the second straight line may be determined. The first position represents the idling start point, and the second position represents the idling end point.

Second, a target idling path is determined based on the idling start point, the first straight line, the idling end point and the second straight line.

The target idling path is two tangential circles, a tangent of the two tangential circles at the idling start point is the first straight line, and a tangent of the two tangential circles at the idling end point is the second straight line.

As an example, the operation 2 above can be realized in a following manner (including a first operation and a second operation): at the first operation, target double circles are determined based on the first position, the first straight line, the second position and the second straight line.

The target double circles are two tangential circles, a tangent of the target double circles at the first position is the first straight line, and a tangent of the target double circle at the second position is the second straight line.

Here, in a case of double-arc spline construction, two end points (i.e., the first position and the second position described above) and two direction vectors (representing the two moving directions described above) are known, and in addition to a case where two direction vectors are in a same direction or in opposite directions, countless double circles can be determined so that they are tangential at a start point (e.g., the first position), a connecting point of the double circles (e.g., a tangential point of the two circles) and an end point (e.g., the second position). Among many double circles, double circles with a same first length and a same second length can be determined as the target double circles.

Here, the first length and the second length of each pair of double circles can be determined in a following manner:
First, a tangent at a tangential point between the double circles (hereinafter referred to as a first tangential point) is determined to obtain a first tangent.
Second, a tangent of the double circles at the first position (hereinafter referred to as a second tangential point) is determined to obtain a second tangent. A tangent of the double circles at the second position (hereinafter referred to as a third tangential point) is determined to obtain a third tangent.
Third, an intersection of the first tangent and the second tangent is determined to obtain a first intersection. An intersection of the first tangent and the third tangent is determined to obtain a second intersection.
Fourth, a length between the first intersection and the second tangential point is determined as the first length, and a length between the second intersection and the third tangential point is determined as the second length.

At the second operation, the idling path is constructed based on the target double circles.

As an example, among paths formed by the target double circles, a shortest path around the circles can be selected, and thus the idling path can be obtained.

It can be understood that in the above application scenarios, the idling path is determined by geometric construction, which can make a length of the idling path shorter and thus improves a printing speed.

In some application scenarios in the above alternative implementations, the idling path also can be constructed in a following manner:

First, an initial function relation formula for path construction is determined.

The initial function relation formula contains parameters to be determined.

Second, a constraint equation of the initial function relation formula is determined.

Third, a target function relation formula representing the curve of the idling path is determined based on the constraint equation and the initial function relation formula to construct the idling path.

As an example, if there are i axes, then the initial function relation formula for path construction can be determined as Pᵢ(t)=aᵢt⁵+bᵢt⁴+cᵢt³+dᵢt²+eᵢt+fᵢ, where 0≤t≤T. For each axis, the initial function relation formula above contains the parameters to be determined (e.g., unknowns) aᵢ, bᵢ, cᵢ, dᵢ, eᵢ, fᵢ and T. Here, six boundary constraints (coordinates, speed and acceleration of the first position, coordinates, speed and acceleration of the second position) can be used to generate 6×i equations, and meanwhile a shortest duration T can be solved by using a maximum speed of and an acceleration limit for the idling. For a number of coordinate axes indicated by i, for example, i can be 3 for a three-dimensional rectangular coordinate system, and i can be 2 for a two-dimensional coordinate system.

Taking online velocity planning as an example, it is assumed that a starting coordinate (that is, a coordinate of the first position described above) of the idling is A and an ending coordinate (that is, a coordinate of the second position described above) is B, where A and B can be a two-dimensional coordinate, a printing speed at a point A is a printing speed directly before the idling, and a speed at a point B is a speed in a first printing moving segment after the idling. Planning is respectively made on A and B in two dimensions to respectively calculate times for moving in the two dimensions from A to B. A velocity planning method includes, but is not limited to, T-type, S-type, sin-type and other velocity planning types, and with constraints such as v₁, v₂, a maximum speed and a maximum acceleration of the idling, it is verified with the maximum speed and the maximum acceleration whether the planning is qualified or objectives and the constraints needs to be adjusted. Taking one dimension of the two dimensions with longer time as reference, the maximum speed of the other of the two dimensions is reduced to make time of the two dimensions equal (keeping a final speed of the dimension with the reduced speed unchanged), and an entire process trajectory of moving in the two dimensions respectively is an actual trajectory of idling, and thus, the objective function relation of the curve representing the idling path can be obtained to construct the idling path. It can be understood that in the above application scenarios, the idling path can be determined in a planning manner.

It should be noted that, in addition to contents described above, this example can also include corresponding technical features described in a corresponding example in FIG. 1, so as to achieve technical effect of the method for controlling movement of the print head shown in FIG. 1, which can be referred to related description in FIG. 1 for details and is not repeated here for brevity.

According to the method for controlling movement of the print head according to the example of the disclosure, the material withdrawing operation is first performed by the print head before the print head reaches the idling start point, and the material refilling operation is first performed by the print head before the print head reaches the idling end point, thus reducing or even avoiding occurrence of stringing at the nozzle caused by no performing of the material withdrawing operation and the material refilling operation when the print head reaches the idling point, and improving the printing efficiency.

Exemplary description of the example of the disclosure is made in the following, but it should be noted that the example of the disclosure may have features described below, but the following description does not constitute limitation on the protection scope of the example of the disclosure.

It should be noted that this method is only exemplified with exponential acceleration and deceleration herein. In practice, with technical enlightenment given by this disclosure, those skilled in the art can also apply this scheme to other acceleration and deceleration modes. For example, this scheme can be applied to S-type acceleration and deceleration, trapezoidal acceleration and deceleration, triangular acceleration and deceleration, etc.

Before introducing this scheme, related terms are explained and illustrated as follows:

Idling, which indicates that the print head moves without extruding the material.

Withdrawing, which is an operation to prevent crossed extrusion or dripping during printing. When the print head needs to move to a new position without extruding the material (such as plastic), the printer can slightly pull (withdraw) the material back to inside of the print head to prevent the material from dripping during movement.

Refilling, which indicates that when the print head arrives at a new printing position after withdrawing and is ready to start material extrusion again, the printer can push out (refill) the previously withdrawn material again.

CN continuity, which indicates that a function is continuous in its domain, and all its derivatives are also continuous. Here, “N” indicates an order of derivative, for example, C0 continuity means that the function itself is continuous, C1 continuity means that the function and its first-order derivative are continuous, C2 continuity means that the function, its first-order derivative and its second-order derivative are continuous, and the like.

Currently, when 3D printing is carried out by an FDM process, a mechanism for dealing with idling is to first cause the print head to stop moving before the idling begins, then an extrusion shaft starts to withdraw, and after the withdrawing is made in place, the idling starts, and after the idling is made in place, refilling is started, after which printing of an outline continues. This entire process is usually performed sequentially, which takes a long time.

In this regard, this method takes advantage of hysteresis response characteristics of the extruder (that is, after a pressure is applied to the material in the print head, actual extrusion time of the material is delayed relative to pressure applying time), controls the extrusion shaft of the print head to withdraw in advance and refill in advance in combination with the extrusion path, and constructs a smooth curve, so that speed reduction at the idling start point and the idling end point is not obvious (that is, a moving speed of the print head changes little during an entire printing process), thus shortening a waiting duration for process execution and a duration for speed reduction between the idling start point and the idling end point.

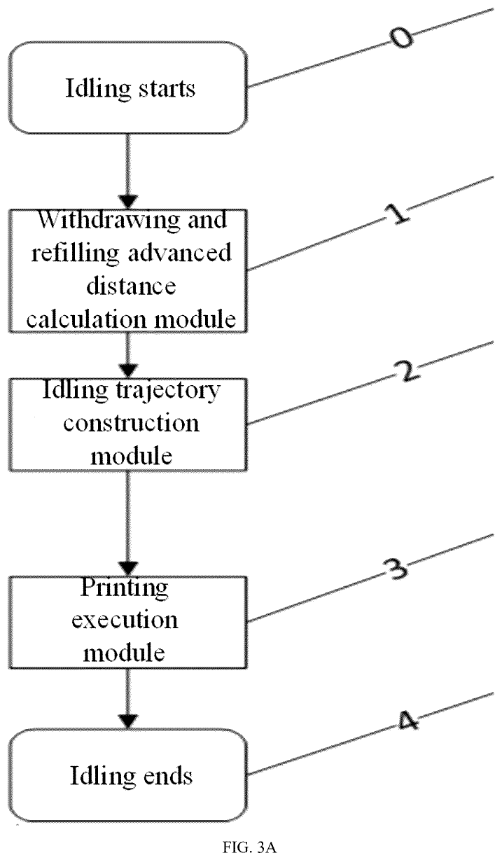

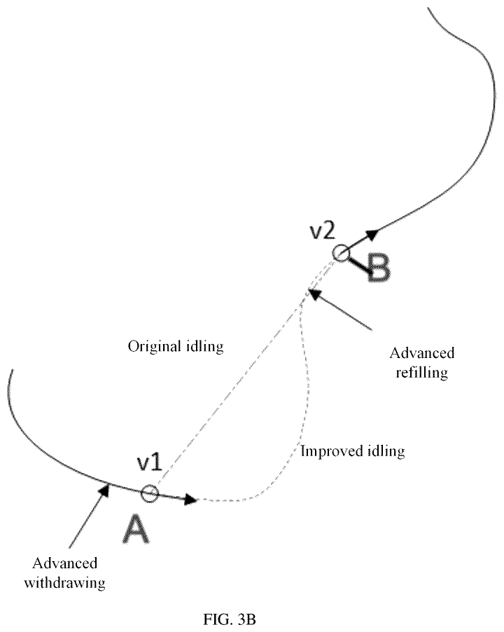

Specific implementation operations are shown in FIG. 3A, including following operations.

At operation 0, the idling starts. Referring to FIG. 3B, there are continuous idling start point (e.g., the idling start point described above) and end point (e.g., the idling end point described above) b on a processing path (e.g., the operation path described above). An idling movement process is between point A and point B (constituting the idling path), and a set length L₁ for withdrawing and a set length L₂ for refilling, and withdrawing acceleration aₘₐₓ₁ and refilling acceleration aₘₐₓ₂ of the idling path are obtained, v₁ and v₂ are respectively a printing speed directly before the idling at the point A and a speed in the first printing moving segment after the idling.

At operation 1, advanced distances for withdrawing and refilling are determined in a withdrawing and refilling advanced distance calculation module. A main purpose of this module is to determine a corresponding distance L_{A} from start time of the withdrawing to start time of the idling and a corresponding distance L_{B} from start time of the refilling to end time of the idling. These distances (that is, a distance between the idling point described above and the material withdrawing and refilling point to be determined) can be determined manually or by using the response characteristics of the extruder along with the exponential acceleration and deceleration.

In an idling process, velocity planning for a trajectory curve and action planning for the extrusion, withdrawing and refilling are performed independently and asynchronously to ensure a smooth operation trajectory.

The distance L_{A} is determined as follows. The extrusion speed eᵣₐₜᵢₒ×v₁ is decelerated to a speed of 0 at the idling start point A in advance in exponential deceleration according to the hysteresis of the extruder, and then the extruder is switched to withdraw the material in the print head by the withdrawing distance L₁ in the idling process to ensure no dripping and leakage. In the distance L₁, the withdrawing action in the distance L₁ is planned according to constraints on start and end speeds of 0, the maximum acceleration and the speed (the withdrawing action refers to extrusion speeds at different locations along the distance L₁). The refilling is performed in advance in exponential acceleration, and the extruder continues to extrude at a speed of eᵣₐₜᵢₒ×v₂ (a discharge speed is proportional to the speed of the print head) by the distance L₂ to the point B. After the point B, the material extruding action starts and printing of an outline continues. Meanwhile, at set withdrawing and refilling accelerations according to maximum accelerations at starts of the exponential acceleration and deceleration, duration of the advanced withdrawing t₁ meets:

$${t}_{1} = α \times {T}_{1} = \frac{- {e}_{ratio} \times {v}_{1}}{- {a}_{max 1}} ,$$

and duration of the advanced refilling t₂ meets:

$${t}_{2} = α \times {T}_{2} = \frac{{e}_{ratio} \times {v}_{2}}{{a}_{max 2}} .$$

aₘₐₓ₁ represents the maximum acceleration at the idling start point A, aₘₐₓ₂ represents the maximum acceleration at the idling end point B, and a represents a change rate of material acceleration, which, for example, can be 3 to 5, and T₁ and T₂ are time constants of withdrawing and refilling stages respectively.

The maximum speed involves a maximum speed in each axis (for example, x, y, z) and an overall maximum speed for respective axes. The maximum acceleration involves a maximum acceleration in each axis (for example, x, y, z) and an overall maximum acceleration for respective axes.

According to the above relation formula, values of T₁ and T₂ can be obtained.

Further, it can be obtained that: L_{A}=eᵣₐₜᵢₒ×v₁×T₁×(1−e^{-α}), and L_{B}=eᵣₐₜᵢₒ×v₂×T₂×(α−1+e^{-α})+L₂.

α represents the change rate of material acceleration, which is generally 3 to 5, eᵣₐₜᵢₒ is an extrusion ratio (which can be determined based on a height and a line width of the material), extrusion speeds at printing speeds v₁ and v₂ are eᵣₐₜᵢₒ×v₁ and eᵣₐₜᵢₒ×v₁ respectively, and e is a natural constant, also called Euler number.

At operation 2, an idling trajectory construction module is configured to generate an idling trajectory. Generation of the idling trajectory can be directly made from geometric figures, and a generation method can be a geometric construction method such as double circle spline, hyperbolic helix and B spline, or can be an online velocity planning method for direct generation.

For example, the printing trajectory at the idling start and end points is CN continuous, where N is generally 1 or 2, which can be determined according to the geometric construction method. In constructing the idling path, the curvature of the trajectory in the idling should be kept as small as possible, and a curvature of 0 means that two endpoints are in a same direction and the trajectory is a straight line, and curvature variation of the trajectory in the idling is ensured to be as small as possible.

As an example, a curve can be constructed in following manners.

Geometric construction: assuming that it is constructed by the double circular spline and two endpoints and two direction vectors are known, in addition to a case where the two direction vectors are in a same direction or in opposite directions, countless double circles can be constructed so that they are tangential at a start point, a connecting point of the double circles and an end point, and a short smooth path around the circles can be selected.

Planning construction: assuming that there are i axes (for example, there can be three axes for three-dimensional coordinates, x, y and z axes respectively), with an initial function relation formula of Pᵢ(t)=aᵢt⁵+bᵢt⁴+cᵢt³+dᵢt²+eᵢt+fᵢ, 0<=t<=T, and now there are 7 unknowns, a, b, c, d, e, f and T (that is, the parameters to be determined above); and six boundary constraints (start and end positions, speed and acceleration) can be used to generate 6×i equations (that is, the constraint equation above), and meanwhile a shortest duration T can be solved by using a maximum speed of and an acceleration limit for the idling.

Taking online velocity planning as an example, it is assumed that a starting coordinate (that is, a coordinate of the first position described above) of the idling is A and an ending coordinate (that is, a coordinate of the second position described above) is B, where A and B both are a coordinate, a printing speed at a point A is a printing speed directly before the idling, and a speed at a point B is a speed in a first printing moving segment after the idling. Planning is respectively made on A and B in two dimensions. A velocity planning method includes, but is not limited to, T-type, S-type, sin-type and other velocity planning types, and with constraints such as v₁, v₂, a maximum speed and a maximum acceleration of the idling, it is verified whether the planning is qualified or objectives and the constraints needs to be adjusted. Taking one dimension of the two dimensions with longer time as reference, the maximum speed of the other of the two dimensions is reduced to make time of the two dimensions equal (keeping a final speed of the dimension with the reduced speed unchanged), and an entire process trajectory of moving in the two dimensions respectively is an actual trajectory of idling.

At operation 3, a printing execution module is configured to periodically control movement in a horizontal trajectory and movement of an extrusion motor. Trajectory movement for printing and idling is carried out using the distances in operation 1 and the trajectory constructed in operation 2. The withdrawing and the refilling are performed according to the advanced distances.

At operation 4, the idling ends.

It should be noted that, in addition to contents described above, this example can also include technical features described in above examples, so as to achieve technical effect of the method for controlling movement of the print head shown above, which can be referred to description above for details and is not repeated here for brevity.

According to the method for controlling movement of the print head according to the example of the disclosure, withdrawing and refilling process operations for extrusion are respectively performed in advance before an end of printing and before an end of idling, so that process switching time before and after the idling can be shortened, and acceleration and deceleration time of the print head in a translation trajectory can be shortened, thereby improving overall processing efficiency. Moreover, the smooth idling trajectory is constructed so that a movement speed of the print head is not reduced to zero at the idling start point and the idling end point, which can reduce jitter of the print head caused by large acceleration or speed during the idling.

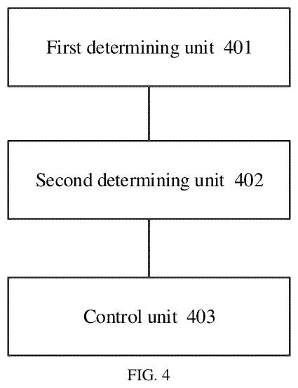

FIG. 4 is a schematic diagram of a device for controlling movement of a print head according to an example of the present disclosure. The device specifically includes a first determining unit 401, a second determining unit 402 and a control unit 403.

The first determining unit 401 is configured to determine an idling point on an operation path, the idling point includes an idling start point and an idling end point.

The second determining unit 402 is configured to determine a material withdrawing and refilling point based on the idling point, the material withdrawing and refilling point being located before at least one of the idling start point and the idling end point; and to control the print head to start a material withdrawing and refilling operation in a case where the print head moves to the material withdrawing and refilling point according to the operation path.

The control unit 403 is configured to control the print head to move to the idling end point.

In a possible example, the idling point includes the idling start point and the idling end point, and the material withdrawing and refilling point includes a material withdrawing point and a material refilling point.

The determining the material withdrawing and refilling point based on the idling point includes: determining a material withdrawing point based on the idling start point, the print head performing a material withdrawing operation in a case where the print head moves to the material withdrawing point; determining a material refilling point based on the idling end point, the print head performing a material refilling operation in a case where the print head moves to the material refilling point.

The controlling the print head to move to the idling end point includes: controlling the print head to move in a following order: the material withdrawing point, the idling start point, the material refilling point, and the idling end point.

In a possible example, after the idling point on the operation path is determined, the device further includes a construction unit and a n updating unit.

The construction unit (not shown) is configured to construct a target idling path between the idling start point and the idling end point.

The updating unit (not shown) is configured to update a path between the idling start point and the idling end point in the operation path into the idling path so as to obtain an updated operation path.

The controlling the print head to move to the idling end point includes: controlling the print head to move according to the updated operation path.

In a possible example, the target idling path satisfies at least one of following conditions: a curve of the idling path has first-order continuity; the curve representing the idling path satisfies a preset curvature condition; or the curve representing the idling path satisfies a preset curvature variation condition.

In a possible example, the idling path is constructed in a following manner: a first straight line and a second straight line are determined, the first straight line represents a straight line where a moving direction of the print head at the idling start point is located, and the second straight line represents the straight line where a moving direction of the print head at the idling end point is located; and a target idling path is determined based on the idling start point, the first straight line, the idling end point and the second straight line, the target idling path is two tangential circles, a tangent of the two tangential circles at the idling start point is the first straight line, and a tangent of the two tangential circles at the idling end point is the second straight line.

In a possible example, the idling path is constructed in a following manner: an initial function relation formula for path construction is determined, the initial function relation formula contains parameters to be determined; a constraint equation of the initial function relation formula is determined; and an objective function relation formula representing the curve of the idling path is determined based on the constraint equation and the initial function relation formula to construct the idling path.

In a possible example, the determining the material withdrawing and refilling point based on the idling point includes: determining the material withdrawing and refilling point based on a preset target distance and the idling point. The target distance represents a distance between the idling point and the material withdrawing and refilling point to be determined.

The device for controlling movement of the print head according to this example can be the device for controlling movement of the print head as shown in FIG. 4, and can perform all of operations of the methods for controlling movement of the print head described above, so as to achieve technical effect of the methods for controlling movement of the print head described above, which can be referred to related description above for details and is not repeated here for brevity.

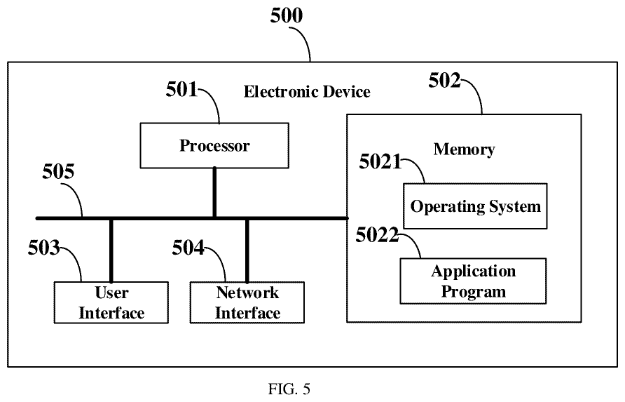

FIG. 5 is a schematic diagram of an electronic device according to an example of the present disclosure. The electronic device 500 shown in FIG. 5 includes at least one processor 501, a memory 502, at least one network interface 504 and other user interfaces 503. Various components in the electronic device 500 are coupled together by a bus system 505. It can be understood that the bus system 505 is configured to realize connection communication between these components. The bus system 505 includes a power bus, a control bus and a status signal bus in addition to a data bus. But for sake of clarity, various buses are all labeled as the bus system 505 in FIG. 5.

The user interface 503 may include a display, a keyboard or a pointing device (for example, a mouse, a trackball, a touch panel or a touch screen).

It can be understood that the memory 502 in the example of the present disclosure may be a volatile memory or a nonvolatile memory, or may include both volatile and nonvolatile memories. The nonvolatile memory can be a Read-Only Memory (ROM), a programmable read-only memory (PROM), an erasable programmable read-only memory (EPROM), an electrically erasable programmable read-only memory (EEPROM), or a flash memory. The volatile memory may be a Random Access Memory (RAM), which is used as an external cache. By way of example, but not limitation, many forms of RAM are available, such as a static random access memory (SRAM), a dynamic random access memory (DRAM), a synchronous DRAM (SDRAM), a Double Data Rate SDRAM (DDRSDRAM), an enhanced SDRAM (ESDRAM), a Synch link DRAM (SLDRAM) and a Direct Rambus RAM (DRRAM). The memory 502 described herein is intended to include, but is not limited to, these and any other suitable types of memory.

In some examples, the memory 502 stores following elements, executable units or data structures, or subsets thereof, or extended sets thereof: an operating system 5021 and an application program 5022.

The operating system 5021 includes various system programs, such as a framework layer, a core library layer, a driver layer, etc., which are used to realize various basic services and to handle hardware-based tasks. The application program 5022 includes various application programs, such as a Media Player and a Browser, which are used to realize various application services. A program for implementing the method of the example of the present disclosure may be included in the application program 5022.

In this example, by calling programs or instructions stored in the memory 502, specifically, programs or instructions stored in the application program 5022, the processor 501 is configured to perform operations of the method according to various method examples, which for example include: determining an idling point on an operation path, the idling point including an idling start point and an idling end point; determining a material withdrawing and refilling point based on the idling point, the material withdrawing and refilling point being located before at least one of the idling start point and the idling end point; controlling the print head to start a material withdrawing and refilling operation in a case where the print head moves to the material withdrawing and refilling point according to the operation path; and controlling the print head to move to the idling end point.

The method disclosed in the example of the present disclosure can be applied to the processor 501 or implemented by the processor 501. The processor 501 may be an integrated circuit chip with signal processing capability. In an implementation process, respective operations of the above method can be completed by an integrated logic circuit of hardware or an instruction in a form of software in the processor 501. The processor 501 may be general processors, Digital Signal Processors (DSPs), application specific integrated circuits (ASICs), Field Programmable Gate Arrays (FPGA) or other programmable logic devices, discrete gate or transistor logic devices, or discrete hardware components. The methods, operations and logic blocks disclosed in the examples of the present disclosure can be implemented or executed. The general processor can be a microprocessor or the processor can be any conventional processor, etc. Operations of the method disclosed in the example of the present disclosure can be directly embodied to be executed and completed by a hardware decoding processor, or to be executed and completed by a combination of hardware and software units in the decoding processor. Software units can be located in a random access memory, a flash memory, a read-only memory, a programmable read-only memory or an electrically erasable programmable memory, registers and other mature storage media in the art. The storage medium is located in the memory 502, and the processor 501 reads information in the memory 502 to complete operations of the above method in combination with its hardware.

It is understood that the examples described herein can be implemented in hardware, software, firmware, middleware, microcode or a combination thereof. For hardware implementations, the processing unit can be implemented in one or more disclosure specific integrated circuits (ASICs), Digital Signal Processing (DSPs), DSP devices (DSPDs), Programmable Logic Devices (PLDs), Field-Programmable Gate Arrays (FPGAs), general processors, controllers, microcontrollers, microprocessors, other electronic units for performing above functions of the present disclosure, or a combination thereof.

For software implementations, techniques described herein can be realized by units that perform functions described herein. Software codes can be stored in the memory and executed by the processor. The memory may be implemented in the processor or external to the processor.

The electronic device according to this example can be the electronic device as shown in FIG. 5, and can perform all of operations of the methods for controlling movement of the print head described above, so as to achieve technical effect of the methods for controlling movement of the print head described above, which can be referred to related description above for details and is not repeated here for brevity.

A storage medium (computer readable storage medium) is further provided in an example of the disclosure. The storage medium herein stores one or more programs. The storage medium can include a volatile memory, such as a random access memory; the memory can also include a non-volatile memory, such as a read-only memory, a flash memory, a hard disk or a solid state hard disk; and the memory may also include a combination of above types of memories.

When one or more programs in the storage medium can be executed by one or more processors, the method for controlling movement of the print head executed on the electronic device side can be implemented.

The processor above is configured to execute a printing program stored in the memory to realize following operations of the method for controlling movement of the print head executed on an electronic device side: determining an idling point on an operation path, the idling point including an idling start point and an idling end point; determining a material withdrawing and refilling point based on the idling point, the material withdrawing and refilling point being located before at least one of the idling start point and the idling end point; controlling the print head to start a material withdrawing and refilling operation in a case where the print head moves to the material withdrawing and refilling point according to the operation path; and controlling the print head to move to the idling end point.

Those of professional skill in the art can further realize that units and algorithm steps of each example described in combination with the examples disclosed herein can be implemented by electronic hardware, computer software or combination thereof. In order to clearly illustrate the interchangeability of hardware and software, the composition and steps of the examples have been described generally by function in the above description. Whether these functions are implemented by hardware or software depends on specific application and design constraints of the technical solution. Those of professional skill can use different methods to realize the described functions for each specific application, but the realization should not be considered beyond the scope of the present disclosure.

The steps of the methods or algorithms described in the examples disclosed herein may be implemented in hardware, a processor-executed software module, or a combination of both. The software module may be placed in random access memory (RAM), memory, read-only memory (ROM), electrically programmable ROM, electrically erasable programmable ROM, register, hard disk, removable magnetic disk, CD-ROM, or any other form of storage medium known in the art.

It should be understood that the terms used herein are only for the purpose of describing specific exemplary examples and are not intended to be limiting. Unless the context clearly indicates otherwise, the singular forms “a”, “an” and “the” as used herein can also mean including plural forms. The terms “include”, “including”, “comprise” and “comprising” are inclusive and thus indicate the presence of features, steps, operations, elements and/or components described, but do not exclude the presence or addition of one or more other features, steps, operations, elements, components, and/or combinations thereof. The method steps, processes, and operations described herein are not interpreted as necessarily requiring them to be executed in the specific order described, unless the execution order is explicitly indicated. It should also be understood that additional or alternative steps may be used.

What has been described above is only specific examples of the disclosure, which enables those skilled in the art to understand or realize the disclosure. Various modifications to these examples will be obvious to those skilled in the art, and general principles defined herein can be implemented in other examples without departing from the spirit or scope of this disclosure. Therefore, the disclosure will not be limited to the examples illustrated herein, but should conform to the widest scope consistent with the principles and novel features disclosed herein.

What is claimed is:

1. A method for controlling movement of a print head, comprising:
determining an idling point on an operation path, wherein the idling point comprises an idling start point and an idling end point;
determining, based on the idling point, a material withdrawing and refilling point, wherein the material withdrawing and refilling point is located before at least one of the idling start point and the idling end point;
controlling the print head to start a material withdrawing and refilling operation after determining that the print head moves to the material withdrawing and refilling point according to the operation path; and
controlling the print head to move to the idling end point.

2. The method according to claim 1, wherein the material withdrawing and refilling point comprises a material withdrawing point and a material refilling point,
wherein determining the material withdrawing and refilling point comprises:
determining, based on the idling start point, the material withdrawing point, wherein the print head performs a material withdrawing operation after determining that the print head moves to the material withdrawing point; and
determining, based on the idling end point, the material refilling point, wherein the print head performs a material refilling operation after determining that the print head moves to the material refilling point; and
wherein controlling the print head to move to the idling end point comprises:
controlling the print head to move in following order: the material withdrawing point, the idling start point, the material refilling point, and the idling end point.

3. The method according to claim 1, further comprising:
after determining the idling point on the operation path, constructing a target idling path between the idling start point and the idling end point; and
updating a path between the idling start point and the idling end point, in the operation path to the target idling path, to obtain an updated operation path,
wherein controlling the print head to move to the idling end point comprises:
controlling the print head to move to the idling end point according to the updated operation path.

4. The method according to claim 3, wherein the target idling path satisfies at least one of following conditions:
a curve representing the idling path has first-order continuity;
a curve representing the idling path satisfies a preset curvature condition; or
a curve representing the idling path satisfies a preset curvature variation condition.

5. The method according to claim 3, wherein constructing the target idling path comprises:
determining a first straight line and a second straight line, wherein the first straight line represents a straight line in a moving direction of the print head at the idling start point, and the second straight line represents a straight line in a moving direction of the print head at the idling end point; and
determining the target idling path based on the idling start point, the first straight line, the idling end point and the second straight line, wherein the target idling path comprises two tangential circles, a tangent of the two tangential circles at the idling start point is the first straight line, and a tangent of the two tangential circles at the idling end point is the second straight line.

6. The method according to claim 3, wherein constructing the target idling path comprises:
determining an initial function relation formula for path construction, wherein the initial function relation formula contains parameters to be determined;
determining a constraint equation of the initial function relation formula; and
determining a target function relation formula representing a curve of the idling path based on the constraint equation and the initial function relation formula to construct the target idling path.

7. The method according to claim 1, wherein determining the material withdrawing and refilling point based on the idling point comprises:
determining the material withdrawing and refilling point based on a preset target distance and the idling point, wherein the preset target distance represents a distance between the idling point and the material withdrawing and refilling point to be determined.

8. An electronic device comprising:
one or more processors; and
memory storing instructions that, when executed by the one or more processors, cause the electronic device to:
determine an idling point on an operation path, wherein the idling point comprises an idling start point and an idling end point;
determine, based on the idling point, a material withdrawing and refilling point, wherein the material withdrawing and refilling point is located before at least one of the idling start point and the idling end point;
control a print head to start a material withdrawing and refilling operation after determining that the print head moves to the material withdrawing and refilling point according to the operation path; and
control the print head to move to the idling end point.

9. The electronic device according to claim 8, wherein the idling point corresponds to a print head movement without material extrusion.

10. The electronic device according to claim 8, the material withdrawing and refilling point comprises a material withdrawing point and a material refilling point, wherein the instructions, when executed by the one or more processors, cause the electronic device to:
determine the material withdrawing and refilling point by:
determining, based on the idling start point, the material withdrawing point, wherein the print head performs a material withdrawing operation after determining that the print head moves to the material withdrawing point; and
determining, based on the idling end point, the material refilling point, wherein the print head performs a material refilling operation after determining that the print head moves to the material refilling point; and
control the print head to move to the idling end point by:
controlling the print head to move in following order: the material withdrawing point, the idling start point, the material refilling point, and the idling end point.

11. The electronic device according to claim 8, wherein the instructions, when executed by the one or more processors, cause the electronic device to:
after determining the idling point on the operation path, construct a target idling path between the idling start point and the idling end point; and
update a path between the idling start point and the idling end point, in the operation path to the target idling path, to obtain an updated operation path,
wherein the instructions, when executed by the one or more processors, further cause the electronic device to control the print head to move to the idling end point by:
controlling the print head to move to the idling end point according to the updated operation path.

12. The electronic device according to claim 10, wherein the target idling path satisfies at least one of following conditions:
a curve representing the idling path has first-order continuity;
a curve representing the idling path satisfies a preset curvature condition; or
a curve representing the idling path satisfies a preset curvature variation condition.

13. The electronic device according to claim 10, wherein the instructions, when executed by the one or more processors, cause the electronic device to construct the target idling path by:
determining a first straight line and a second straight line, wherein the first straight line represents a straight line in a moving direction of the print head at the idling start point, and the second straight line represents a straight line in a moving direction of the print head at the idling end point; and
determining the target idling path based on the idling start point, the first straight line, the idling end point and the second straight line, wherein the target idling path comprises two tangential circles, a tangent of the two tangential circles at the idling start point is the first straight line, and a tangent of the two tangential circles at the idling end point is the second straight line.

14. The electronic device according to claim 10, wherein the instructions, when executed by the one or more processors, cause the electronic device to construct the target idling path by:
determining an initial function relation formula for path construction, wherein the initial function relation formula contains parameters to be determined;
determining a constraint equation of the initial function relation formula; and
determining a target function relation formula representing a curve of the idling path based on the constraint equation and the initial function relation formula to construct the target idling path.

15. One or more non-transitory media storing instructions that, when executed, cause a computing device to:
determine an idling point on an operation path, wherein the idling point comprises an idling start point and an idling end point;
determine, based on the idling point, a material withdrawing and refilling point, wherein the material withdrawing and refilling point is located before at least one of the idling start point and the idling end point;
control a print head to start a material withdrawing and refilling operation after determining that the print head moves to the material withdrawing and refilling point according to the operation path; and
control the print head to move to the idling end point.

16. The non-transitory media according to claim 15, wherein the material withdrawing and refilling point comprises a material withdrawing point and a material refilling point, wherein the instructions, when executed, cause the computing device to determine the material withdrawing and refilling point by:
determining, based on the idling start point, the material withdrawing point, wherein the print head performs a material withdrawing operation after determining that the print head moves to the material withdrawing point; and
determining, based on the idling end point, the material refilling point, wherein the print head performs a material refilling operation after determining that the print head moves to the material refilling point; and
wherein the instructions, when executed, cause the computing device to control the print head to move to the idling end point by:
controlling the print head to move in following order: the material withdrawing point, the idling start point, the material refilling point, and the idling end point.

17. The non-transitory media according to claim 15, wherein the instructions, when executed, cause the computing device to:
after determining the idling point on the operation path, construct a target idling path between the idling start point and the idling end point; and
update a path between the idling start point and the idling end point, in the operation path to the target idling path, to obtain an updated operation path,
wherein the instructions, when executed, cause the computing device to control the print head to move to the idling end point by:
controlling the print head to move to the idling end point according to the updated operation path.

18. The non-transitory media according to claim 17, wherein the target idling path satisfies at least one of following conditions:
a curve representing the idling path has first-order continuity;
a curve representing the idling path satisfies a preset curvature condition; or
a curve representing the idling path satisfies a preset curvature variation condition.

19. The non-transitory media according to claim 17, wherein the instructions, when executed, cause the computing device to construct the target idling path by:
determining a first straight line and a second straight line, wherein the first straight line represents a straight line in a moving direction of the print head at the idling start point, and the second straight line represents a straight line in a moving direction of the print head at the idling end point; and
determining the target idling path based on the idling start point, the first straight line, the idling end point and the second straight line, wherein the target idling path comprises two tangential circles, a tangent of the two tangential circles at the idling start point is the first straight line, and a tangent of the two tangential circles at the idling end point is the second straight line.

20. The non-transitory media according to claim 17, wherein the instructions, when executed, cause the computing device to construct the target idling path by:
determining an initial function relation formula for path construction, wherein the initial function relation formula contains parameters to be determined;
determining a constraint equation of the initial function relation formula; and
determining a target function relation formula representing a curve of the idling path based on the constraint equation and the initial function relation formula to construct the target idling path.
